(19) United States
(12) Patent Application Publication
(10) Pub. No.: US 2005/0194954 A1
(43) Pub. Date: Sep. 8, 2005

(54) Bandgap reference current source

(75) Inventor: Dieter Draxelmayr, Villach (AT)

Correspondence Address: Maginot, Moore & Beck;Bank One Tower, Suite 3000, 111 Monument Circle, Indianapolis, IN, 46204, US

(73) Assignee: Infineon Technologies AG, Munchen (DE)

(21) Appl. No.: 11/045,796

(22) Filed: Jan. 28, 2005

(30) Foreign Application Priority Data
Jan. 28, 2004 (DE) 10 2004 004 305.1

(51) Int. Cl. G05F 3/16

(52) U.S. Cl. 323/313

(57) ABSTRACT

Bandgap reference current source for generating a reference current (I_{REF}) having: at least two bipolar transistors (T₁, T₂),
the base terminals (B₁, B₂) of which are interconnected and connected to a fixed reference potential,
the collector terminals (C₁, C₂) of which are connected to a collector current ratio setting circuit (15, 16), which sets a specific current ratio (m) between the two collector currents (I_{C1}, I_{C2}) flowing through the collector terminals (C₁, C₂),
and the emitter terminals (E₁, E₂) of which are connected via a first resistor (R_{A}) to a current node (13) which adds the emitter currents (I_{E1}, I_{E2}) flowing through the emitter terminals (E₁, E₂) to form a summation current (I_{SUM}), which forms the reference current (I_{REF}).

The invention relates to a bandgap reference current source for generating a reference voltage.

Bandgap reference current sources or bandgap circuits are in widespread use in integrated circuits.

FIG. 1 shows a subcircuit of a bandgap reference current source according to the prior art. The subcircuit in accordance with FIG. 1 contains an operational amplifier OP having an inverting input (−) and a noninverting input (+). The output of the operational amplifier OP supplies a voltage (V_{REF}), which is present at the gate terminals of two PMOS transistors P_{A}, P_{B} in order to close a control loop. A supply voltage V_{DD} is present at the PMOS transistor P_{A}, P_{B}. The first PMOS transistor P_{A} is connected to the noninverting signal input (+) of the operational amplifier OP and, via a resistor R_{A}, to a diode D_{A}. The second PMOS transistor P_{B} is connected to the inverting signal input (−) of the operational amplifier OP and is connected to ground via a diode D_{B}. The two diodes D_{A} and D_{B} have a specific current density ratio n.

The offset voltage of the operational amplifier greatly influences the accuracy of the circuit arrangement illustrated in FIG. 1. Ideally, the subcircuit supplies a current

$${I}_{A} = \frac{{U}_{T}}{{R}_{A}} .$$

lnn flowing through the resistor R_{A}. Since the voltage U_{T}·lnn is small and generally has a value of 10 to 100 mV the current I_{A} is greatly dependent on the offset voltage of the operational amplifier.

If the subcircuit illustrated in FIG. 1 is integrated on a chip, the diodes are formed in the form of pn junctions Drain/BULK or Well/Substrate.

FIG. 2 shows a bandgap reference voltage source according to the prior art, as is described for example in U. Tietze, C. H. Shenk, 11^{th} Edition, Springer Verlag (ISBN 3-540-64192-0), on pp. 175-977.

The bandgap reference voltage source according to the prior art such as is illustrated in FIG. 2 likewise contains an operational amplifier OP having an inverting input (−) and a noninverting input (+), the inverting input being connected via a resistor R₃ to a supply voltage V_{DD} and the noninverting input (+) being connected via a resistor R₄ to the supply voltage V_{DD}. The resistance of the resistor R₄ is a factor n lower than the resistance of the resistor R₃.

The bandgap reference voltage source according to the prior art such as is illustrated in FIG. 2 contains two bipolar transistors T₁, T₂, the collector terminal of the first bipolar transistor T₁ being connected to the resistor R₃ and the collector terminal of the second bipolar transistor T₂ being connected to the resistor R₄. The base terminals of the two bipolar transistors T₁, T₂ are connected to the output of the operational amplifier OP. The emitter terminal of the first bipolar transistor T₁ is connected to a potential node K via a resistor R₁. The emitter terminal of the second bipolar transistor T₂ is also connected to the potential node K. The potential node K is connected to ground via a resistor R₂.

The reference voltage V_{REF} generated is present at the output of the operational amplifier OP.

The base-emitter voltage U_{BE2} of the second transistor T₂ is used as a voltage reference, although the temperature coefficient thereof is very high with a value of −2 mV/K at 0.6 V. This temperature coefficient is compensated for by adding a voltage with a temperature coefficient of +2 mV/K. In the case of the bandgap reference voltage according to the prior art as illustrated in FIG. 2, said compensation voltage is generated by means of the second transistor T₂. The two bipolar transistors T₁, T₂ are operated with different collector currents I_{C2}>I_{C1}.

A voltage drop results on the transfer characteristic curve of the resistor R₁:

$$\begin{matrix}Δ {U}_{BE} = {U}_{{BE}_{2}} - {U}_{{BE}_{1}} \\ = {U}_{T} ln \frac{{I}_{C2}}{{I}_{C1}} \\ = \frac{k \cdot T}{q} ln \frac{{I}_{C2}}{{I}_{C1}}\end{matrix} \qquad ( 1 )$$

where T is the absolute temperature, and q is the elementary charge.

The voltage drop ΔU_{BE} is proportional to the voltage equivalent of thermal energy U_{T} and thus proportional to the absolute temperature T.

A correspondingly larger voltage drop results at the resistor R₂ since not only the collector current

$${I}_{C1} = \frac{Δ {U}_{BE}}{{R}_{1}} ,$$

but also the further collector current I_{C2} flows through the resistor R₂.

The operation amplifier OP sets its output voltage in such a way that I_{C2}=n·I_{C1} holds true.

The following thus results:

$$\begin{matrix}\begin{matrix}{U}_{Temp} = {R}_{2} ( {I}_{C1} + {I}_{C2} ) \\ = {R}_{2} \frac{Δ {U}_{BE}}{{R}_{1}} ( 1 + n ) \\ = {U}_{T} \frac{{R}_{2}}{{R}_{1}} ( 1 + n ) ln n \\ = {AU}_{T}\end{matrix} & ( 2 ) \\ \begin{matrix}{U}_{REF} = {U}_{Temp} + {U}_{BE2} \\ = constant\end{matrix} & ( 3 )\end{matrix}$$

Arbitrary gain factors A can be realized through the choice of the current ratio n and the resistance ratio R₂/R₁.

The bandgap reference voltage source according to the prior art as shown in FIG. 2 contains operational amplifier OP.

FIG. 3 shows a circuitry construction of a simple operational amplifier with a MOS differential amplifier stage.

Operational amplifiers that are integrated on a chip in CMOS technology have a high offset voltage. The bandgap reference voltage sources according to the prior art as shown in FIGS. 1, 2 are very sensitive toward alterations of the offset voltage of the operational amplifier OP, i.e. small changes in the offset voltage lead to high deviations in the reference voltage. The variation in the offset voltage caused by the production process thus leads to a high fluctuation of the reference voltage V_{REF} output by the bandgap reference voltage source.

Therefore, the object is to provide a bandgap reference current source which generates a readily reproducible, accurate reference current that is insensitive to process variations.

This object is achieved according to the invention by means of a bandgap reference current source having the features specified in Patent claim 1.

The invention provides a bandgap reference current source for generating a reference current having at least two bipolar transistors T₁, T₂, the base terminals B₁, B₂ of which are interconnected and connected to a fixed reference potential,

the collector terminals C₁, C₂ of which are connected to a collector current ratio setting circuit, which sets a specific current ratio (m) between the two collector currents flowing through the collector terminals and the emitter terminals E₁, E₂ of which are connected via a first resistor R_{A} to a current node which adds the emitter currents flowing through the emitter terminals to form a summation current (I_{SUM}), which forms the reference current (I_{REF}).

One advantage of the bandgap reference current source according to the invention is that the amplification is effected in one stage, i.e. no operational amplifier is necessary, with the result that a reference voltage generated is not altered by varying offset voltages.

This is because the amplifying components are formed by the two bipolar transistors T₁, T₂ themselves. In contrast to conventional bandgap circuits in bipolar technology, however, the circuit according to the invention is insensitive to variations in the current gain and Early voltage. A relatively accurate reference current I_{REF} is generated even with a current gain of less than 1.0 V.

A further advantage of the reference current source according to the invention is that it requires a minimum supply voltage V_{DD} of only approximately 1.0 V.

In one preferred embodiment of the bandgap reference current source according to the invention the summation current flowing at the current node is mirrored by means of current mirror transistors to form a mirrored summation current (I_{SUM′}), which flows through the second resistor (R_{B}) for generating a reference voltage (V_{REF}).

The collector current ratio setting circuit preferably has
a first reference current source pair which generates two reference currents (I_{REF1}, I_{REF2}) in the specific current ratio (m) and
a second reference current source pair, which generates two reference currents (I_{REF3}, I_{REF4}) in the specific current ratio (m).

In one preferred embodiment, the first reference current source pair contains a first reference current source for generating a first reference current (I_{REF1}), and a second reference current source generating a second reference current (I_{REF2}).

In one preferred embodiment, the second reference current source pair contains has a third reference current source for generating a third reference current (I_{REF3}), and a fourth reference current source for generating a fourth reference current (I_{REF4}).

In one preferred embodiment, of the bandgap reference current source according to the invention, the first reference current source and the third reference current source are connected to the collector terminal (C₁) of the first bipolar transistor (T₁).

In one preferred embodiment, of the bandgap reference current source according to the invention, the second reference current source and the fourth reference current source are connected to the collector terminal (C₂) of the second bipolar transistor (T₂).

In one preferred embodiment, the first reference current source has a plurality (m) of MOS transistors connected up in parallel.

In one preferred embodiment, the third reference current source has a plurality (m) of MOS transistors connected up in parallel.

In a further preferred embodiment of the bandgap reference current source according to the invention, a cascode circuit is provided between the first reference current source pair and the collector terminals (C₁, C₂) of the bipolar transistors (T₁, T₂).

In one preferred embodiment of the bandgap reference current source according to the invention, the first reference current source pair is connected to a first supply voltage (V_{DD}).

In one preferred embodiment, the second reference current source pair is connected to a second supply voltage (V_{SS}).

In one preferred embodiment the second supply voltage (V_{SS}) forms the reference potential for the base terminals (B₁, B₂) of the bipolar transistors, (T₁, T₂).

In one preferred embodiment of the bandgap reference current source according to the invention, a third resistor R_{C} is connected up between the current node (K) and the two base terminals (B₁, B₂), a diode current (I₃) flowing through said third resistor.

In one preferred embodiment, the resistors (R_{A}, R_{B}, R_{C}) are dimensioned in such a way that the reference voltage (V_{REF}) is temperature-compensated.

In one preferred embodiment of the bandgap reference current source according to the invention, the bandgap reference voltage source is an integrated circuit.

In one preferred embodiment, the bandgap reference voltage source is a CMOS circuit.

The bipolar transistors (T₁, T₂) are preferably parasitic bipolar transistors of the integrated circuit.

In this case, the bipolar transistors are PNP bipolar transistors in a first embodiment.

In a second embodiment, the bipolar transistors are NPN transistors.

In one preferred embodiment of the band gap reference current source according to the invention, the resistors (R_{A}, R_{B}, R_{C}) are integrated resistors produced from the same material.

In one preferred embodiment, the two bipolar transistors (T₁, T₂) have the same component parameters.

In a further preferred embodiment of the bandgap reference current source according to the invention, the two bipolar transistors (T₁, T₂) have a specific current density ratio

$$n \cdot ( \frac{{I}_{E1}}{{I}_{E2}} ) = ( n \cdot m ) .$$

Furthermore, preferred embodiments of the bandgap reference current source according to the invention are described with reference to the accompanying figures in order to elucidate features that are essential to the invention.

### IN THE FIGURES

FIG. 1 shows the first subsection of a bandgap reference current source for generating a reference current according to the prior art;

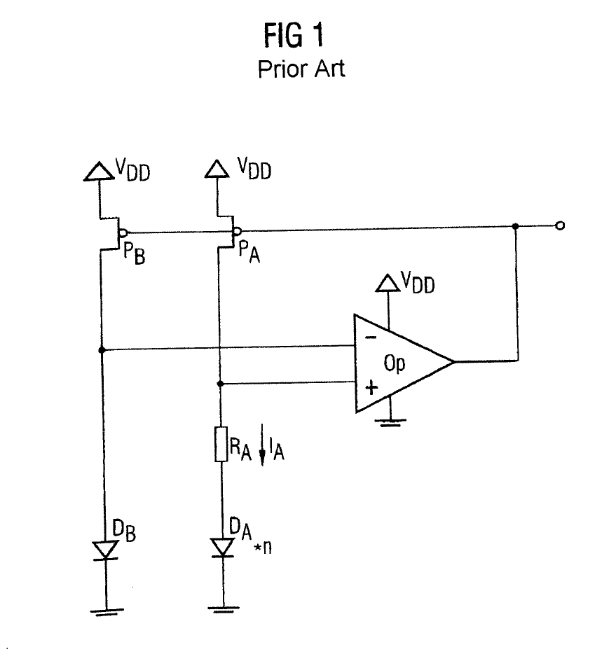

FIG. 2 shows a bandgap reference voltage source for generating a reference voltage according to the prior art;

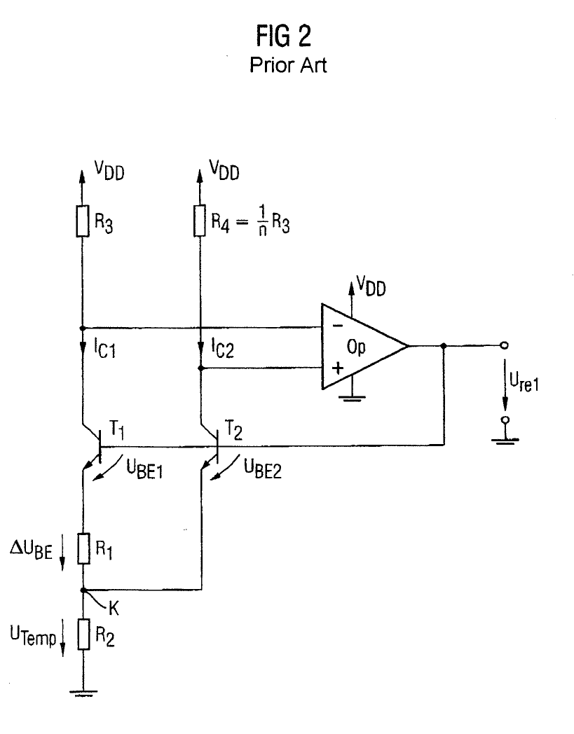

FIG. 3 shows a simple operational amplifier with a MOS differential amplifier stage according to the prior art;

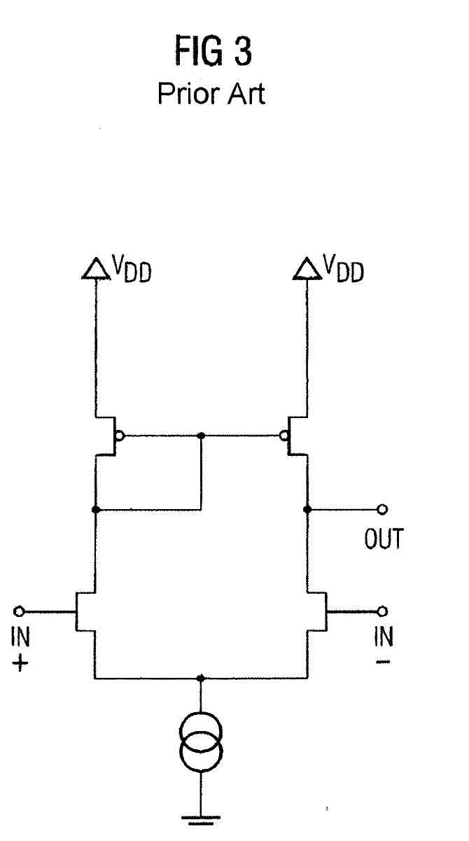

FIG. 4 shows a preferred embodiment of the bandgap reference current source according to the invention;

FIG. 5 shows a sectional view through an integrated circuit for elucidating the parasitic bipolar transistors connected up in a preferred embodiment.

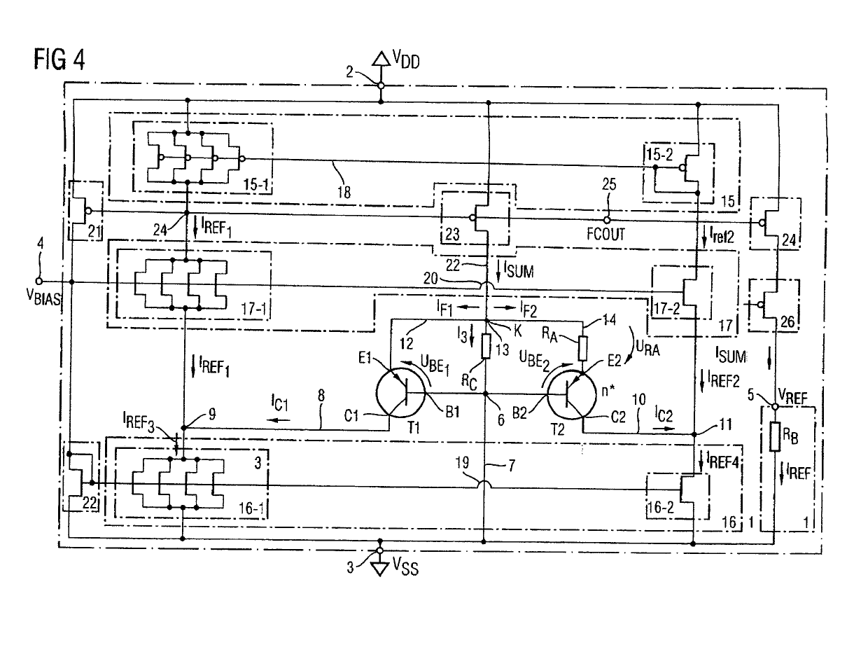

FIG. 4 shows a preferred embodiment of the bandgap reference current source 1 according to the invention. The reference current source 1 has a first supply voltage terminal 2 for applying a first supply voltage V_{DD} and a second supply voltage terminal 3 for applying a second supply voltage V_{SS}. Moreover, a reference current source 1 has a terminal 4 for applying a Bias voltage (V_{BIAS}) and an output terminal 5 for outputting the reference current (I_{REF}).

The bandgap reference current source 1 contains two bipolar transistors T₁, T₂, the base terminals B₁, B₂ Of which are interconnected at a node 6, the node 6 being connected to a fixed reference potential via a line 7. In the case of the preferred embodiment in FIG. 4, the fixed reference potential is formed by the second supply voltage V_{SS}. The collector terminal C₁ of the first bipolar transistor T₁ is connected to a node 9 via a line 8, the collector current I_{C1} of the first bipolar transistor T₁ flowing via a line 8. The collector C₂ of the second bipolar transistor T₂ is connected to a further node 11 via a line 10, the collector current I_{C2} of the second bipolar transistor T₂ flowing via a line 10. The emitter E₁ of the first bipolar transistor T₁ is connected via a line 12 to a current node 13, which is connected to the emitter E₂ of the second bipolar transistor T₂ via a line 14 and a first resistor R_{A}.

The bandgap reference current source 1 has two reference current source pairs 15, 16. The first reference current source pair 15 contains a first reference current source 15-1 and a second reference current source 15-2. The second reference current source pair 16 contains a first reference current source 16-1 and a second reference current source 16-2.

The two reference current source pairs 15, 16 in each case generate two reference currents, the current magnitudes of which have a specific current ratio (m).

In the case of the preferred embodiment illustrated in FIG. 4, the current ratio m has a value of 4. The first reference current source pair 15 generates a first reference current I_{REF1}, and a second reference current I_{REF2}, which flow via a cascode circuit 17 to the collector terminal contacts 9, 11 of the bipolar transistors T₁, T₂.

The second reference current source pair 16 likewise generates two reference currents I_{REF3}, I_{REF4}, the current magnitudes of which have the same current ratio m. The first reference current source 15-1 generates the first reference current I_{REF1}, which has a current value four times higher than that of the second reference current I_{REF2} generated by the second reference current source 15-2. In the case of the preferred embodiment illustrated in FIG. 4, the first reference current source 15-1 is formed by a plurality of PMOS transistors which are connected up in parallel and the gate terminals of which are connected to an identically constructed PMOS transistor of the second reference current source 15-2 via a line 18.

In the same way, the third reference current source 16-1, in the preferred embodiment illustrated in FIG. 4, is formed by a plurality of NMOS transistors which are connected up in parallel and the gate terminals of which are connected via a line 19 to an identically constructed NMOS transistor of the third reference-current source 16-2. The current ratio m between the reference currents I_{REF} is defined by the number of MOS transistors connected up in parallel in the reference current sources 15-1, 16-1.

The following hold true:
I_{REF1}m·I_{REF2} (4)
I_{REF3}=m·I_{REF4} (5)
I_{REF1}+I_{C1}=I_{REF3} (6)
I_{REF2}+I_{C2}=I_{REF4} (7)
m·I_{REF2}+I_{C1}=I_{REF3} (8)
m·I_{REF2}+I_{C1}=m·I_{REF4} (9)
m·I_{REF2}+I_{C1}=m·I_{REF2}+m·I_{C2} (10)
I_{C1}=m·I_{C2} (11)

The two reference current source pairs 15, 16 form, together with the PMOS transistor 23, a collector current ratio setting circuit, which sets a specific current ratio m between the collector currents I_{C1}, I_{C2} flowing through the collector terminals C₁, C₂. In the case of the preferred embodiment illustrated in FIG. 4, the collector current I_{C1} flowing via the line 8 is four times as high as the collector current I_{C2} flowing via the line 10.

The cascode circuit 17 contains a plurality of NMOS transistors 17-1 which are connected up in parallel and the gate terminals of which are connected via a line 20 to the gate terminal of an identically constructed NMOS transistor 17-2. The gate terminals of the NMOS transistors of the cascode circuit 17 are connected to the terminal 4 for applying a bias voltage. The bias voltage terminal 4 is connected to the supply voltage terminals 2, 3 via a PMOS transistor 21 and an NMOS transistor 22.

The parallel-connected PMOS transistors of the first current source 15-1, the parallel-connected NMOS transistors of the cascode circuit 17 and the parallel-connected NMOS transistors of the third current source 16-2 together form a first current path. A second current path is formed by the PMOS transistor of the second current source 15-2, by the PMOS transistor 17-2 of the cascode circuit 17 and by the PMOS transistor of the fourth reference current source 16-2.

In a preferred embodiment of the bandgap reference current source 1 according to the invention, the node 6 and the summation current node 13 are connected to one another via a third resistor R_{C}.

The following holds true in the settled state:
U_{BE}_{₁}=U_{BE}_{₂}−U_{RA} (12)

In this case, the voltage U_{RA} dropped across the first resistor R_{A} is equal to:
U_{RA}=UT·ln(n·m) (13)
where m specifies the current ratio set by the collector current ratio setting circuit 15, 16, n represents an optionally provided emitter area ratio of the two bipolar transistors T₁, T₂, and n·m represents the current density ratio.

The following holds true for the voltage equivalent of thermal energy UT:

$${U}_{T} = \frac{k \cdot T}{q} \qquad ( 14 )$$

The following hold true for the currents present at the summation current node 13:

$$\begin{matrix}\begin{matrix}{I}_{E2} = \frac{{U}_{RA}}{{R}_{A}} \\ = \frac{{U}_{T} ln ( n \cdot m )}{{R}_{A}}\end{matrix} & ( 15 ) \\ \begin{matrix}{I}_{E1} = m \cdot {I}_{{E}_{2}} \\ = m \cdot \frac{{U}_{T}}{{R}_{A}} ln ( n \cdot m )\end{matrix} & ( 16 ) \\ {I}_{3} = \frac{{U}_{D}}{{R}_{C}} & ( 17 )\end{matrix}$$

The summation current node 13 is connected to a first current mirror transistor 23 via a line 22. In the case of the preferred embodiment illustrated in FIG. 4, the first current mirror transistor 23 is formed by a PMOS transistor, the gate terminal of which is connected to the gate terminal of the PMOS transistor 21 and also the first current path. In addition, the gate terminal of the first current mirror transistor 23 is connected to the gate terminal of a second, identically constructed PMOS transistor 24 via a line 25.

A summation current I_{SUM} flows on the line 22, in which case the following holds true:

$$\begin{matrix}\begin{matrix}{I}_{SUM} = {I}_{E1} + {I}_{E2} + {I}_{3} \\ = ( m + 1 ) \frac{{U}_{T}}{{R}_{A}} ln ( \begin{matrix}n & m\end{matrix} ) + \frac{{U}_{D}}{{R}_{C}}\end{matrix} & ( 18 ) \\ = \frac{( m + 1 ) ln ( n \cdot m )}{{R}_{A}} \cdot \frac{k \cdot T}{q} + \frac{1}{{R}_{C}} \cdot {U}_{D} & ( 19 )\end{matrix}$$

In the case of the preferred embodiment illustrated in FIG. 4, the summation current I_{SUM} formed is mirrored by means of the mirror transistors 23, 24 and conducted via an optionally provided PMOS transistor 26 via a second resistor R_{B}. A reference voltage V_{REF} is generated at the second resistor R_{B} as a result of the summation current I_{SUM} flowing. The following holds true for the reference voltage V_{REF}:

$$\begin{matrix}{V}_{REF} = {I}_{SUM} \cdot {R}_{B} \\ = \frac{{R}_{B}}{{R}_{A}} \cdot ( m + 1 ) ln ( n \cdot m ) \cdot \frac{K \cdot T}{q} + \frac{{R}_{B}}{{R}_{C}} \cdot {U}_{D} \\ = {K}_{1} \cdot {U}_{T} + {K}_{2} \cdot {U}_{D}\end{matrix} \qquad ( 20 )$$

As can be discerned from equation (19), the generated reference voltage V_{REF} is composed of a temperature-proportional voltage component (K₁·U_{T}) and a voltage component (K₂·U_{D}) dependent on the diode voltage. The temperature-proportional component has a positive temperature coefficient, while the voltage component dependent on the diode voltage has a negative temperature coefficient. Through suitable dimensioning of the resistors R_{A}, R_{B}, R_{C} and of the current ratios n, m, it is possible to generate a temperature-compensated reference voltage.

An arbitrary reference voltage V_{REF} can be generated by means of the dimensioning of the resistors R_{A}, R_{B}, R_{C} and the current ratios.

As can be discerned from the equation (19), the current gains (β) of the two bipolar transistors T₁, T₂ have no influence on the magnitude of the reference voltage V_{REF} generated. In the case of the bandgap reference current source 1 according to the invention, what is important is not the absolute current magnitude of the collector currents or the current gain β of the bipolar transistors T₁, T₂, but only the current ratio m between the current paths.

The production parameters of the two bipolar transistors T₁, T₂ can thus have poor properties just as long as they are identical. The bipolar transistors T₁, T₂ can even have a current gain which, under certain circumstances, is less than 1. In this case, the bipolar transistors T₁, T₂ are permitted to have a high substrate current component and a low early voltage. Absolute parameter properties of the two bipolar transistors T₁, T₂ have an effect only in as far as they influence the magnitude of U_{D}, as is the case in every bandgap circuit. The matching between the two bipolar transistors T₁, T₂ is crucial for the generation of the temperature-proportional voltage component. Since it is important merely for the two bipolar transistors to have the same parameter properties, the two bipolar transistors T₁, T₂ are arranged as close as possible to one another in the case of integration of the bandgap reference current source 1 according to the invention, with the result that the parameter properties are matched as well as possible.

Since the bandgap reference current source 1 according to the invention permits the absolute parameter properties of the two bipolar transistors T₁, T₂ to be able to be poor, it is also possible to realize the two bipolar transistors T₁, T₂ of a preferred embodiment by means of parasitic bipolar transistors.

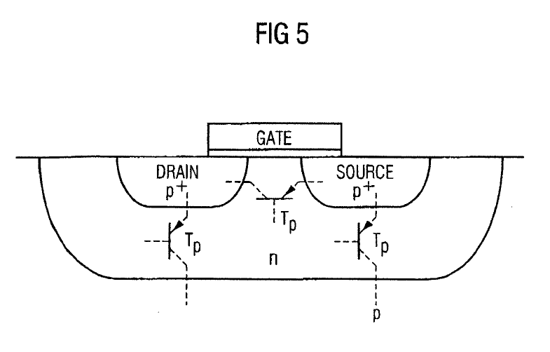

FIG. 5 schematically shows the parasitic bipolar transistors T_{P} present in an integrated MOS transistor. The MOS transistors produced during a CMOS process, for example, thus have parasitic bipolar transistors which can be connected up as bipolar transistors T₁, T₂ in accordance with FIG. 4.

The bandgap reference current source 1 according to the invention tolerates the poor component properties of the bipolar transistors T₁, T₂ without a disadvantageous influence on the reference voltage V_{REF} generated as long as the parameters in the current gain, the substrate current component of the two bipolar transistors T₁, T₂ used, although poor, are nevertheless largely identical. This is the case particularly on integration of the bandgap reference current source 1 according to the invention.

The current sources 15-1, 15-2, 16-1, 16-2 of the reference current source 1 together form a folded cascode amplifier which reacts to a current imbalance at the node 24 with severe excursions. The PMOS transistor 23 is directly connected to the output 24 of the folded cascode amplifier and supplies the bandgap circuit, comprising the two bipolar transistors T₁, T₂ and the resistors R_{A}, R_{C}, with the summation current I_{SUM}. The base terminals B₁, B₂ of the two bipolar transistors T₁, T₂ are connected to the second supply voltage V_{SS} via the line 7, the second supply voltage V_{SS} preferably being formed by ground. Since the two base terminals B₁, B₂ are directly connected to ground, poor current gains of the two bipolar transistors T₁, T₂ are unimportant. A low early voltage of the two bipolar transistors has no adverse influence since the collectors C₁, C₂ are connected to the input terminals 9, 11 of a folded cascode amplifier which keeps the voltage at this node largely constant. Like the base current components, the substrate current components proportional to the operating current have no influence on the reference voltage because to a first approximation, all that is important is the ratio m between the two emitter currents I_{E1}, I_{E2}.

The bandgap circuit 1 according to the invention is insensitive to poor component data. According to the invention, the first resistor R_{A} is connected up in the emitter path, the base terminals B₁, B₂ of the two bipolar transistors T₁, T₂ being interconnected and being supplied well by the reference potential. According to the invention, the collector currents I_{C1}, I_{C2} are coupled out by means of a cascode circuit 17 and form a control output via a further current mirror. The emitter currents I_{E1}, I_{E2} generate a temperature-proportional component of the reference voltage V_{REF}. In a preferred embodiment, the temperature-proportional component of the reference voltage can be temperature-compensated by a diode component by additionally providing a resistor R_{C} connected in parallel with the resistor R_{A}.

The bandgap reference current source 1 according to the invention is distinguished by the fact that it can be operated with a very low supply voltage V_{DD}, the supply voltage being 1 V by way of example. This corresponds to a diode voltage and a saturation voltage. The bandgap circuit 1 according to the invention is outstandingly suitable for integration in an integrated circuit since the absolute component properties of the bipolar transistor T₁, T₂ have no adverse influence on the reference voltage V_{REF}.

1-21. (canceled)

22. A bandgap reference current source for generating a reference current (I_{REF}) having:
(a) at least two bipolar transistors having base terminals that are interconnected and connected to a fixed reference potential, the at least two bipolar transistors having collector terminals that are connected to a collector current ratio setting circuit configured to set a specific current ratio (m) between two collector currents flowing through the collector terminals, the at least two bipolar transistors having emitter terminals that are connected via a first resistor to a current node, the current node configured to add emitter currents flowing through the emitter terminals to form a summation current from which the reference current is formed, the current node also connected to a second resistor, the second resistor being further operably connected to the two base terminals, said second resistor configured to receive a first current (I₃) flowing therethrough,
(b) the collector current ratio setting circuit, comprising
a first reference current source pair configured to generate first and second reference currents in the specific current ratio (m) and
a second reference current source pair configured to generate third and fourth reference currents in the specific current ratio (m).

23. The bandgap reference current source as claimed in claim 22, further comprising current mirror transistors configured to form a mirrored summation current from the summation current, and further comprising a third resistor configured to receive the mirrored summation current and generate a reference voltage therefrom.

24. The bandgap reference current source as claimed in claim 23, wherein the first reference current source pair comprises a first reference current source configured to generate the first reference current, and a second reference current source configured to generate the second reference current.

25. The bandgap reference current source as claimed in claim 24, wherein the second reference current source pair comprises a third reference current source configured to generate the third reference current, and a fourth reference current source configured to generate the fourth reference current.

26. The bandgap reference current source as claimed in claim 25, wherein the first reference current source and the third reference current source are connected to the collector terminal of a first bipolar transistor of the at least two bipolar transistors.

27. The bandgap reference current source as claimed in claim 26, wherein the second reference current source and the fourth reference current source are connected to the collector terminal of a second bipolar transistor of the at least two bipolar transistors.

28. The bandgap reference current source as claimed in claim 24, wherein the first reference current source has a plurality (m) of MOS transistors connected in parallel.

29. The bandgap reference current source as claimed in claim 22, further comprising a cascade circuit coupled between the first reference current source pair and the collector terminals of the at least two bipolar transistors.

30. The bandgap reference current source as claimed in claim 22, wherein the first reference current source pair is connected to a first supply voltage.

31. The bandgap reference current source as claimed in claim 30, wherein the second reference current source pair is connected to a second supply voltage.

32. The bandgap reference current source as claimed in claim 31, wherein the second supply voltage forms a reference potential for the base terminals of the at least two bipolar transistors.

33. The bandgap reference current source as claimed in claim 23, wherein the first, second and third resistors are dimensioned in such a way that the reference voltage generated is temperature-compensated.

34. The bandgap reference current source as claimed in claim 22, wherein the bandgap reference voltage source comprises an integrated circuit.

35. The bandgap reference current source as claimed in claim 34, wherein the bandgap reference voltage source comprises an integrated CMOS circuit.

36. The bandgap reference current source as claimed in claim 34, wherein the at least two bipolar transistors comprise parasitic bipolar transistors of the integrated circuit.

37. The bandgap reference current source as claimed in claim 22, wherein the at least two bipolar transistors comprise PNP transistors.

38. The bandgap reference current source as claimed in claim 22, wherein the at least two bipolar transistors are NPN transistors.

39. The bandgap reference current source as claimed in claim 34, wherein the resistors comprise integrated resistors constructed at least in part of the same material.

40. The bandgap reference current source as claimed in claim 22, wherein the at least two bipolar transistors have substantially similar component parameters.

42. The bandgap reference current source as claimed in claim 22, wherein the at least two bipolar transistors have a specific current density ratio (n).

43. A bandgap reference current source for generating a reference current (I_{REF}) comprising:
(a) at least two bipolar transistors having base terminals that are interconnected and connected to a fixed reference potential, the at least two bipolar transistors having collector terminals that are connected to a collector current ratio setting circuit configured to set a specific current ratio (m) between two collector currents flowing through the collector terminals, the at least two bipolar transistors having emitter terminals that are connected via a first resistor to a current node, the current node configured to add emitter currents flowing through the emitter terminals to form a summation current from which the reference current is formed, the current node also connected to a second resistor, the second resistor being further operably connected to the two base terminals, said second resistor configured to receive a first current (I₃) flowing therethrough,
(b) the collector current ratio setting circuit, comprising
a first reference current source configured to generate two reference currents in the specific current ratio (m) and
a second reference current source configured to generate two currents in the specific current ratio (m).
